(19) United States
(12) Patent Application Publication
(10) Pub. No.: US 2019/0152025 A1
(43) Pub. Date: May 23, 2019

(54) RATCHET WRENCH

(71) Applicant: Yi-Fu Chen, Taichung City (TW)

(72) Inventor: Yi-Fu Chen, Taichung City (TW)

(21) Appl. No.: 15/817,283

(22) Filed: Nov. 20, 2017

(51) Int. Cl. B25B 13/46

(52) U.S. Cl. CPC B25B 13/463

(57) ABSTRACT

A ratchet wrench includes a head with a ratchet wheel rotatably received in a through hole defined through the head. A lateral hole is defined laterally through the wall of the head and communicates with the through hole. A contact portion protrudes inwardly from the inner periphery of the lateral hole so as to reduce the diameter of one end of the lateral hole. A pawl, a spring and a contact member are received in the lateral hole. The spring is biased between the pawl and the contact member, and the pawl is engaged with the ratchet wheel. The contact member is a disk and stopped by the contact portion so that the pawl, the spring and the contact member do not drop from the lateral hole without using a bolt.

### BACKGROUND OF THE INVENTION

### 1. Fields of the Invention

The present invention relates to a ratchet wrench, and more particularly, to a ratchet wrench having a pawl unit including a pawl, a spring and a contact member that is stopped by a shoulder in the lateral hole to prevent the pawl unit from dropping off from the lateral hole.

### 2. Descriptions of Related Art

The conventional ratchet wrench generally includes a ratchet wheel rotatably received in a through hole of the head of the ratchet wrench, and a pawl is movably received in a recess that communicates with the through hole so as to be engaged with the teeth of the ratchet wheel. The pawl is biased by a spring. A threaded hole is defined in the wrench head and communicates with the recess, and a bolt is threadedly connected to the threaded hole to restrict the pawl and the spring in the recess. It is experienced that the threads of the threaded hole are easily worn out due to frequent removal and installation of the bolt, and this may cause the spring and the pawl to be shifted and cannot engage with the ratchet wheel as expected. Even worse, once the bolt is loosened, the spring and the pawl may drop from the wrench head.

The present invention intends to provide a ratchet wrench which does not have the threaded hole and the bolt for restricting the spring and the pawl so as to eliminate the shortcomings mentioned above.

### SUMMARY OF THE INVENTION

The present invention relates to a ratchet wrench which comprises a head with a through hole defined through the top and the bottom thereof. A lateral hole is defined laterally through the wall of the head and communicates with the through hole. The lateral hole includes a first opening and a second opening respectively defined in two ends thereof. The first opening is formed in the inner periphery of the through hole, and the second opening is formed in outside of the head and is smaller than the first opening. A contact portion is formed in the inner periphery of the second opening so as to reduce the diameter of the second opening. A pawl unit is located in the lateral hole and includes a pawl, a spring and a contact member. The spring is biased between the pawl and the contact member. The pawl has a tapered face in which a toothed portion is defined. The contact member is a disk and has a recess defined in the outside thereof. A peripheral portion of the contact member is stopped by the contact portion. A ratchet wheel is rotatably received in the through hole and has ratchet teeth defined in the outer periphery thereof, and the toothed portion of the pawl is engaged with the ratchet teeth of the ratchet wheel.

Preferably, the contact portion protrudes inward from the inner periphery of the second opening, and includes a first section and a second section. The first section is a straight section and the second section is an inclined section. A shoulder is formed between the first and second sections. The peripheral portion of the contact member is stopped by the shoulder of the contact portion.

Preferably, a mounting hole is defined axially through the ratchet wheel and is a polygonal hole.

Preferably, a groove is defined in the inner periphery of the through hole and located close to the top of the head of the ratchet wrench. A flange extends from the inner periphery of the through hole and located close to the bottom of the head of the ratchet wrench. The ratchet wheel is restricted in the through hole and located between the groove and the flange.

Preferably, the ratchet teeth are not in contact with the inner periphery of the through hole.

Preferably, the lateral hole includes a first-diameter section and a second-diameter section. The second-diameter section is defined by the contact portion. The second-diameter section is smaller than the first-diameter section. The pawl unit is located in the first-diameter section. The contact member is stopped at the conjunction area between the first-diameter section and the second-diameter section.

Preferably, the second-diameter section is formed at the second opening.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the ratchet wrench of the present invention;

FIG. 2 is an exploded view of the ratchet wrench of the present invention;

FIG. 3 is a cross sectional view, taken along line III-III of FIG. 1;

FIG. 4 is an enlarged view to show the pawl unit and the contact portion of the present invention;

FIG. 5 is a partial cross sectional view to show the head of the ratchet wrench of the present invention, and

FIG. 6 is a partial cross sectional view to show the head of the ratchet wrench of the present invention, wherein the lateral hole includes the first-diameter section and the second-diameter section.

### DETAILED DESCRIPTION OF THE PREFERRED EMBODIMENT

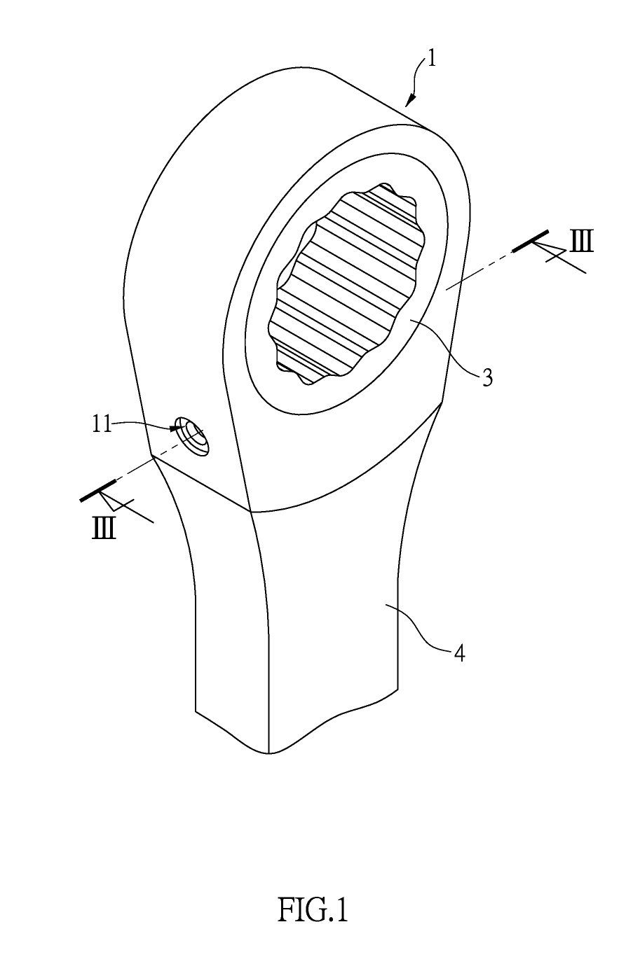

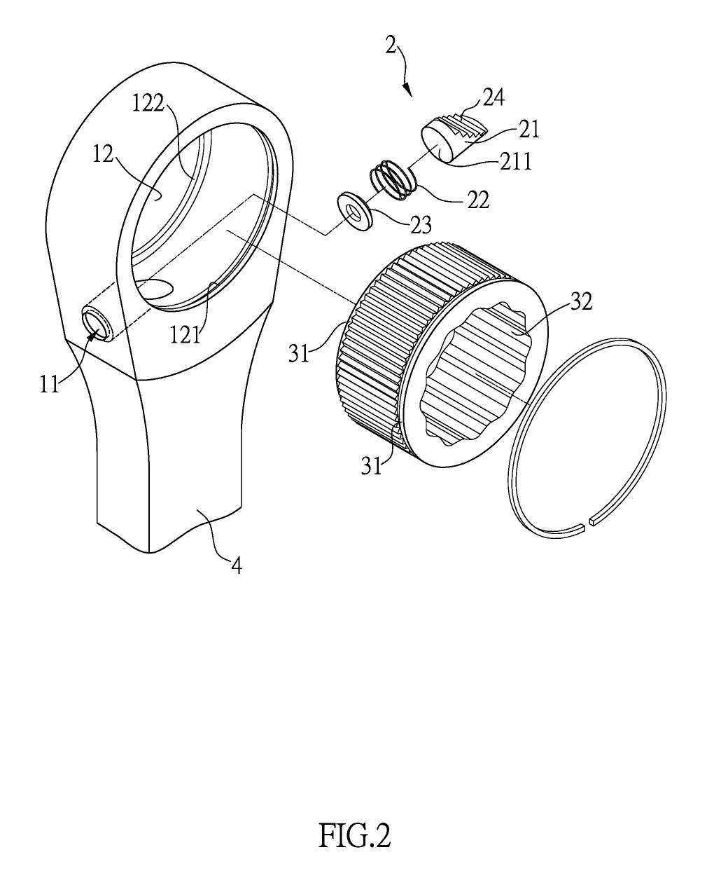

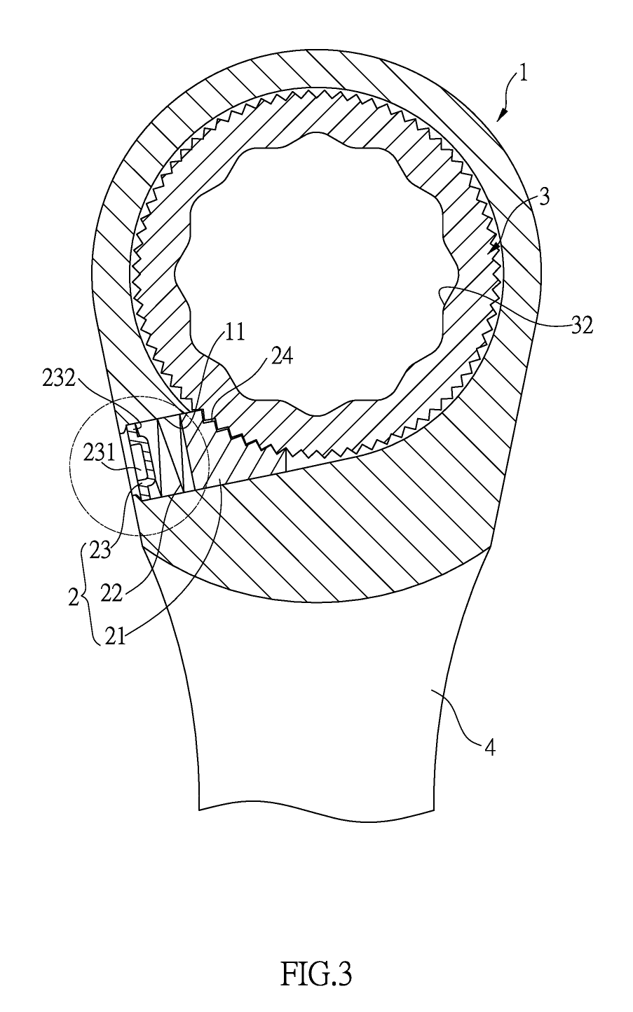

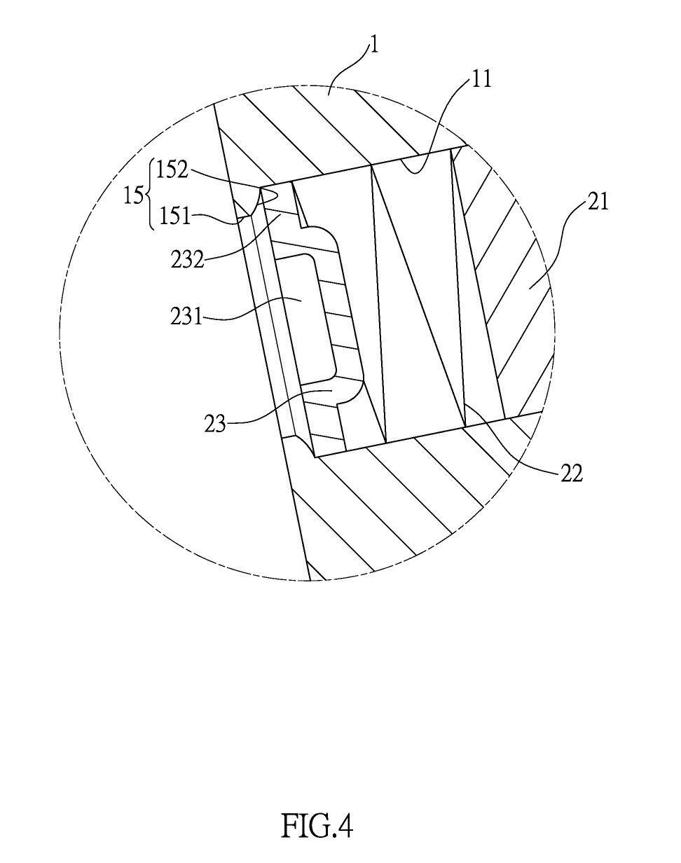

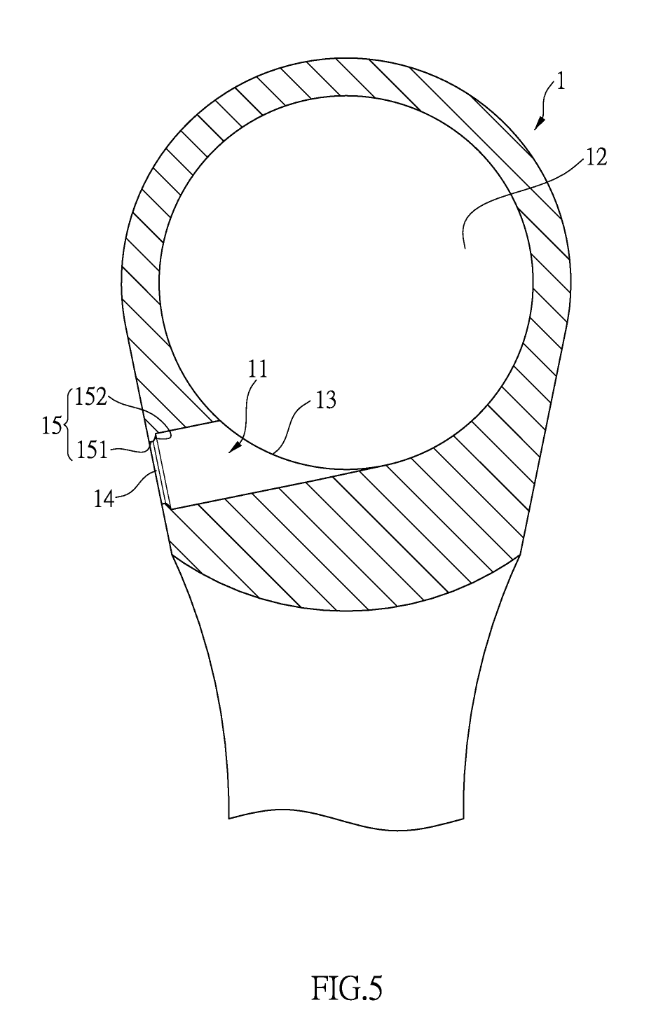

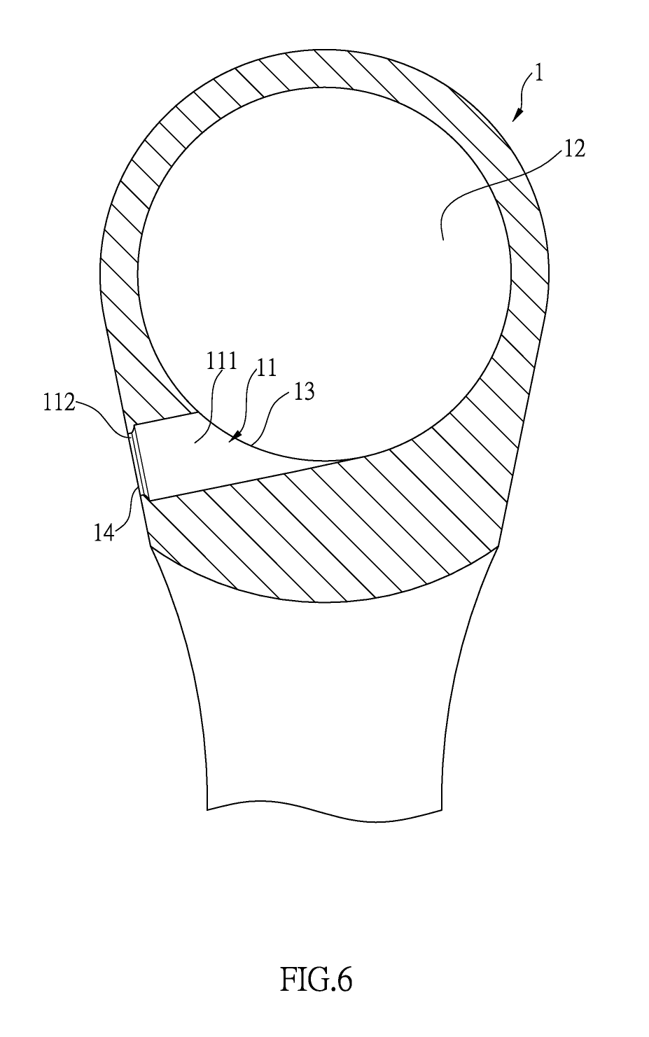

Referring to FIGS. 1 to 6, the ratchet wrench which comprises a head and a handle 4 extending from the head. The head includes a through hole 12 defined through the top and the bottom thereof. A groove 121 is defined in the inner periphery of the through hole 12 and located close to the top of the head of the ratchet wrench 1. A flange 122 extends from the inner periphery of the through hole 12 and located close to the bottom of the head of the ratchet wrench 1. A lateral hole 11 is defined laterally through the wall of the head and communicates with the through hole 12. The lateral hole 11 includes a first opening 13 and a second opening 14 respectively defined in two ends thereof. The first opening 13 is formed in the inner periphery of the through hole 12, and the second opening 14 is formed in outside of the head 11 and is smaller than the first opening 13. Specifically, the lateral hole 11 includes a first-diameter section 111 and a second-diameter section 112. A contact portion 15 is formed in the inner periphery of the second opening 14. The second-diameter section 112 is defined by the contact portion 15. The second-diameter section 112 is smaller than the first-diameter section 111. The second-diameter section 112 is formed at the second opening 14

Specifically, the contact portion 15 protrudes inward from the inner periphery of the second opening 14, and includes a first section 151 and a second section 152. The first section 151 is a straight section and the second section 152 is an inclined section. A shoulder is formed between the first and second sections 151, 152.

A pawl unit 2 is located in the first-diameter section 111 of the lateral hole 12 and includes a pawl 21, a spring 22 and a contact member 23. The spring 22 is biased between the end face 211 of the pawl 21 and the contact member 23. The pawl 21 has a tapered face in which a toothed portion 24 is defined. The contact member 23 is a disk and has a recess 231 defined in the outside thereof. A peripheral portion 232 of the contact member 23 is stopped by the shoulder of the contact portion 15. That is to say, the contact member 23 is stopped at the conjunction area between the first-diameter section 111 and the second-diameter section 112.

A ratchet wheel 3 is rotatably received in the through hole 12 and has ratchet teeth defined in the outer periphery thereof. A mounting hole 32 is defined axially through the ratchet wheel 3 and is a polygonal hole in this embodiment. The ratchet teeth protrude from the outer periphery of the ratchet wheel 3, while there are two protruded portion 31 respectively formed on two ends of the ratchet wheel 3. One of the two protruded portions 31 extends through the space enclosed by the flange 122 so that the ratchet wheel 3 is rested on the flange 122. The other protruded portion 31 includes another groove, so that a clip is engaged with the grove 121 of the head and the groove of the protruded portion 31 of the ratchet wheel 3 so that the ratchet wheel 3 is restricted in the through hole 12 and located between the groove 121 and the flange 122. The ratchet teeth of the ratchet wheel 3 are not in contact with the inner periphery of the through hole 12, and are engaged with the toothed portion 24 of the pawl 21.

When the ratchet wheel 3 is rotated clockwise about the axis of the through hole 12, the pawl 21 is pushed toward the second opening 14 by the ratchet wheel 3 and compresses the spring 22. The ratchet wheel 3 cannot be rotated counter clockwise because the spring 22 biases the toothed portion 24 of the pawl 21 to be engaged with the ratchet wheel 3.

It is noted that the pawl unit 2 is restricted in the lateral hole 11 without using any bolt as used in the conventional ratchet wrench as mentioned before. When replacing the pawl unit 2, the ratchet wheel 3 is first removed from the through hole 12, and the user uses a tool to be engaged with the recess 231 of the contact member 23 from outside of the head, and then pushes the contact member 23 toward the through hole 12 to remove all of the parts of the pawl unit 2 out from the lateral hole 11.

While we have shown and described the embodiment in accordance with the present invention, it should be clear to those skilled in the art that further embodiments may be made without departing from the scope of the present invention.

What is claimed is:

1. A ratchet wrench comprising:
a head with a through hole defined through a top and a bottom thereof, a lateral hole defined laterally through a wall of the head and communicating with the through hole, the lateral hole including a first opening and a second opening respectively defined in two ends thereof, the first opening formed in an inner periphery of the through hole, the second opening being formed in outside of the head and being smaller than the first opening, a contact portion formed in an inner periphery of the second opening so as to reduce a diameter of the second opening;
a pawl unit located in the lateral hole and including a pawl, a spring and a contact member, the spring biased between the pawl and the contact member, the pawl having a tapered face in which a toothed portion is defined, the contact member being a disk and having a recess defined in an outside thereof, a peripheral portion of the contact member being stopped by the contact portion, and
a ratchet wheel rotatably received in the through hole and having ratchet teeth defined in an outer periphery thereof, the toothed portion of the pawl engaged with the ratchet teeth of the ratchet wheel.

2. The ratchet wrench as claimed in claim 1, wherein the contact portion protrudes inward from the inner periphery of the second opening, and includes a first section and a second section, the first section is a straight section and the second section is an inclined section, a shoulder is formed between the first and second sections, the peripheral portion of the contact member is stopped by the shoulder of the contact portion.

3. The ratchet wrench as claimed in claim 2, wherein a mounting hole is defined axially through the ratchet wheel and is a polygonal hole.

4. The ratchet wrench as claimed in claim 3, wherein a groove is defined in the inner periphery of the through hole and located close to the top of the head of the ratchet wrench, a flange extends from the inner periphery of the through hole and located close to the bottom of the head of the ratchet wrench, the ratchet wheel is restricted in the through hole and located between the groove and the flange.

5. The ratchet wrench as claimed in claim 4, wherein the ratchet teeth are not in contact with the inner periphery of the through hole.

6. The ratchet wrench as claimed in claim 1, wherein the lateral hole includes a first-diameter section and a second-diameter section, the second-diameter section is defined by the contact portion, the second-diameter section is smaller than the first-diameter section, the pawl unit is located in the first-diameter section, the contact member is stopped at a conjunction area between the first-diameter section and the second-diameter section.

7. The ratchet wrench as claimed in claim 6, wherein the second-diameter section is formed at the second opening.
